(19) United States
(12) Patent Application Publication
(10) Pub. No.: US 2006/0162236 A1
(43) Pub. Date: Jul. 27, 2006

(54) Detection and elimination of termites

(75) Inventor: John Richard Joseph French, Caloundra (AU)

Correspondence Address: James C Wray, Suite 300, 1493 Chain Bridge Road, McLean, VA, 22101, US

(73) Assignee: ECOSPAN CONSULTING SERVICES PTY LTD

(21) Appl. No.: 10/524,974

(22) PCT Filed: Aug. 18, 2003
(86) PCT No.: PCT/AU03/01044

§ 371 Date: May 16, 2005

(51) Int. Cl. A01M 1/20; A01M 17/00

(52) U.S. Cl. 43/132.1; 43/131

(57) ABSTRACT

A bait station for use in the elimination of termites when detected comprises a hollow body having a plurality of apertures therein and occupying substantially the entire interior of the hollow body in a cellulosic matrix containing a termiticide. The bait station is adapted for attachment to a detector station or a termite infested structure via an exposable aperture by a communicator tube extending between an interior region of said bait station and an interior region of said detector station or said structure to provide a termite pathway between said cellulosic matrix and a termite colony.

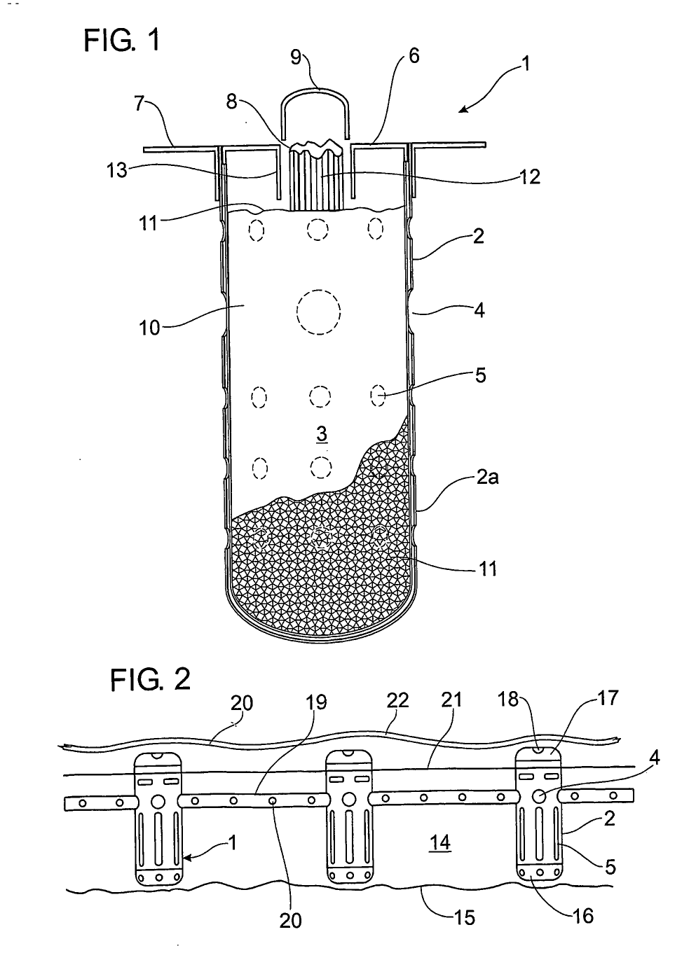

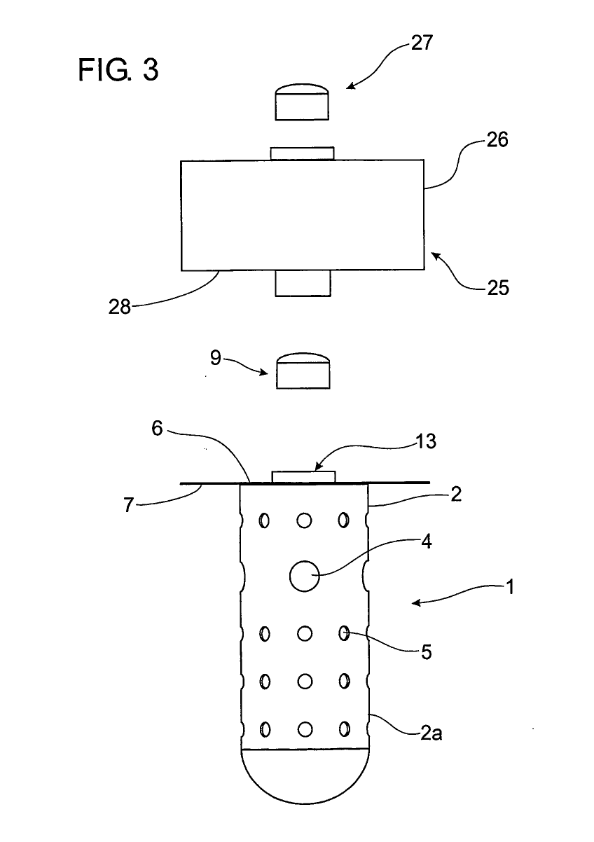

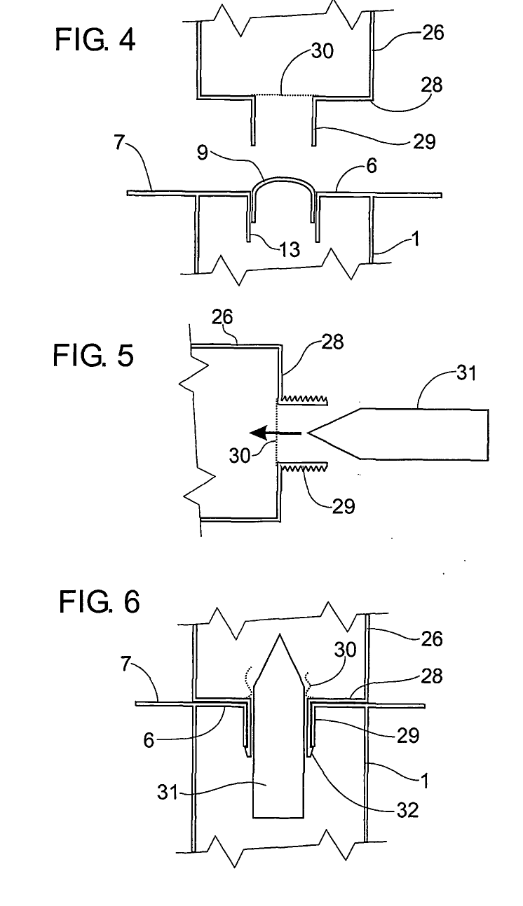

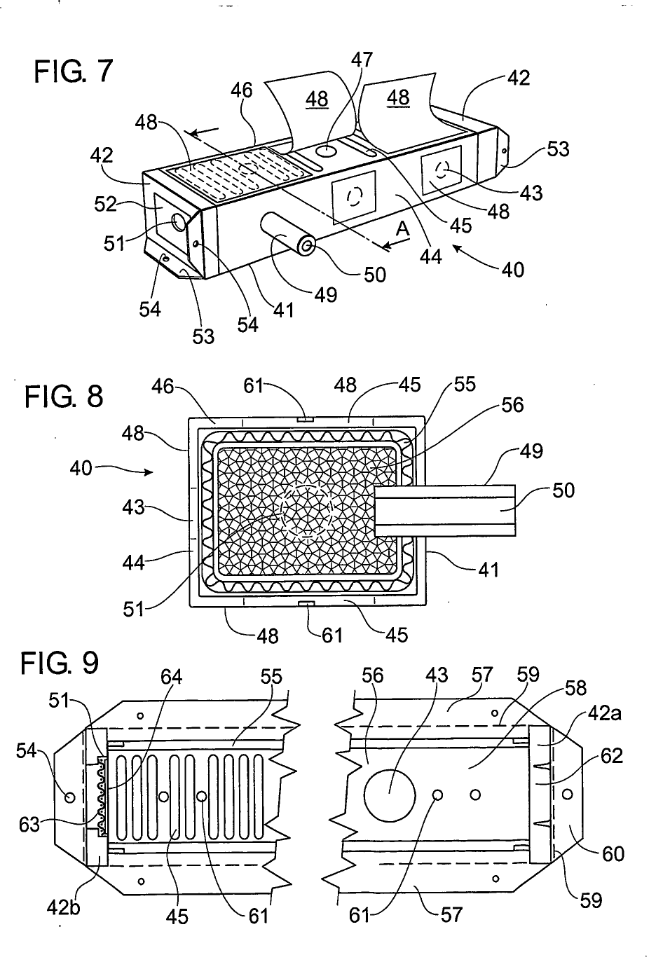

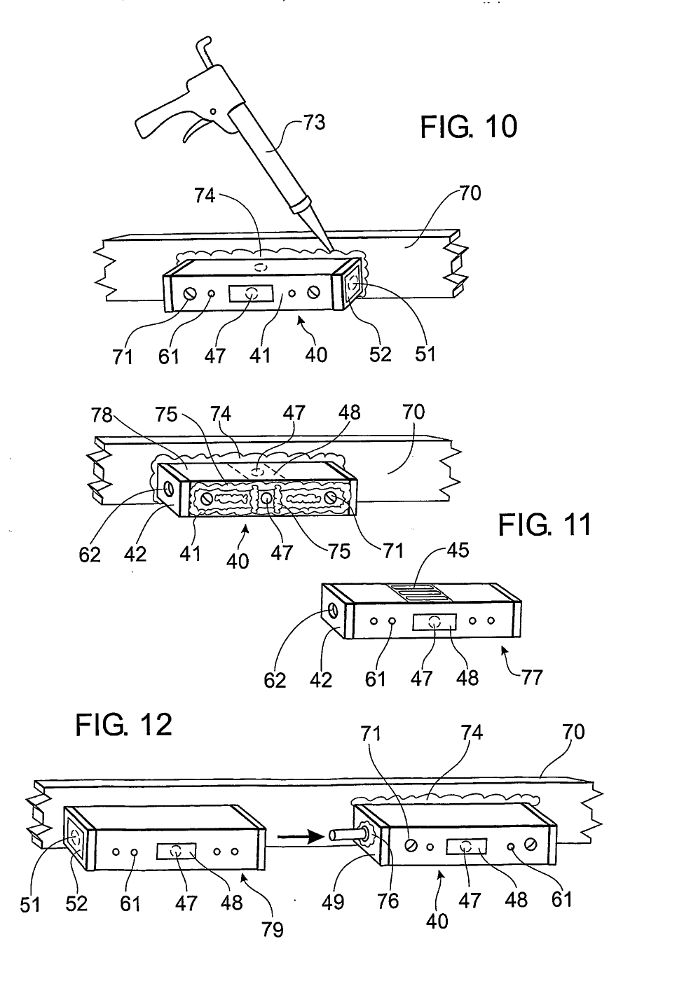

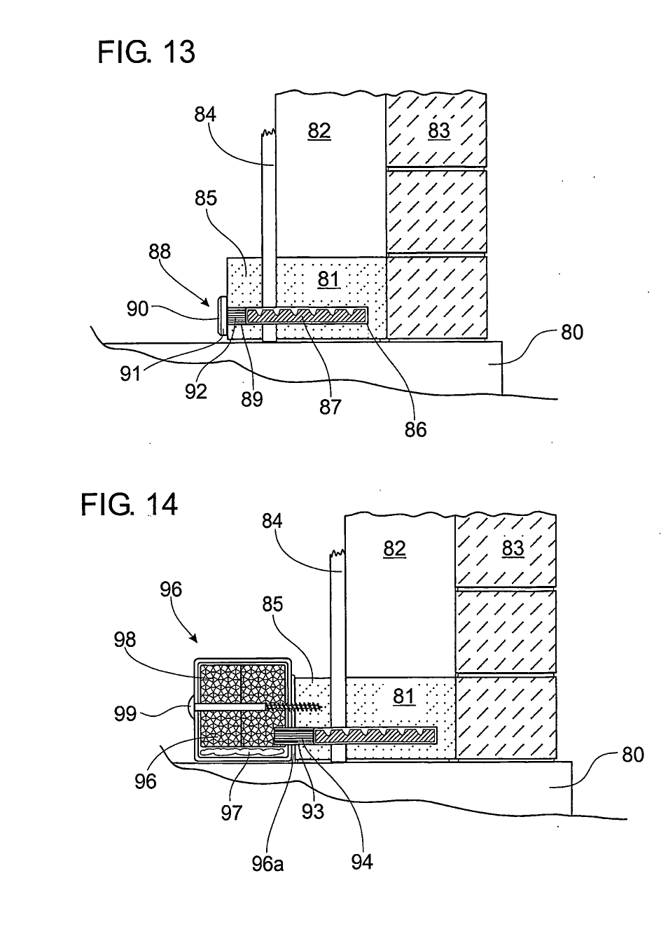

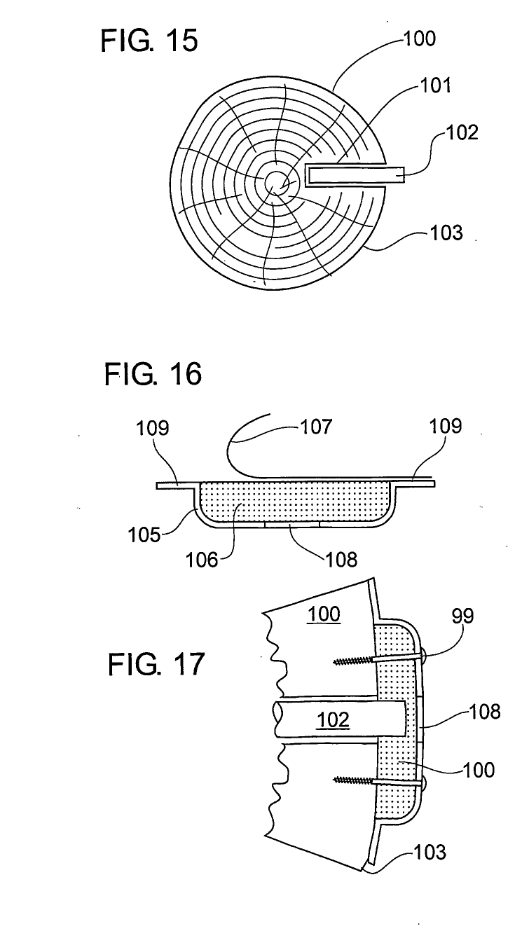

### FIELD OF THE INVENTION

This invention is concerned with the detection and elimination of termites internally and externally of structures.

The invention is concerned particularly although not exclusively with methods and apparatus for detection and/or elimination of subterranean termites and/or termite infestations in structures.

### BACKGROUND OF THE INVENTION

Termite infestation of timber structures is a worldwide problem affecting buildings including domestic dwellings and other timber structures such as bridges, power poles and the like.

Unfortunately most termite infestations in timber structures are not discovered until after extensive damage has been done to the structure, often necessitating removal of wall and ceiling claddings or floors for access to affected structural timber beams or members. In some cases, the extent of damage in a dwelling structure may be such that it is less expensive to demolish and rebuild the structure rather than attempt in-situ repairs. For other structures such as bridges, power poles or the like, there is often no alternative other than to effect in-situ replacement. In either event, the solution to termite damage is extremely costly.

The prevalence of subterranean termite infestations is so great that many local authorities now require the application of a termiticide barrier to the soil upon which a structure such as a domestic dwelling is to be erected. Originally, such termiticides included long lasting organochlorine or organo-phosphorous compounds, but environmental and toxicity considerations now preclude such compositions. A difficulty with chemical barriers is that approved termiticide compositions have a short half-life as low as 90 days, and their effectiveness is compromised by local soil and moisture conditions in many cases.

Typically, up to 500 litres of an aqueous termiticide composition is applied to the “footprint” of the proposed dwelling before the pouring of a concrete slab or the installation of footings and piers. Thereafter at 3 to 5 yearly intervals up to 500 litres of termiticide is applied in a trench around the structure in an endeavour to maintain the termite barrier. In some cases a reticulation system is installed under the concrete slab, but in other cases it is necessary to drill the slab to permit introduction of a liquid termiticide thereunder. While the termiticides used in this process are known to be effective in laboratory tests, there is no experimental data available to support long term in situ effectiveness but in any event the process is environmentally unacceptable.

Because of the generally acknowledged ineffectuality of chemical barrier systems it has been proposed to install stainless steel mesh or crushed granite perimeter barriers about structures such as domestic dwellings. Anecdotal evidence suggests that these physical barriers may be partially effective only if correctly installed and maintained and otherwise not bridged or bridged.

Over the last ten years colony baiting has regained some popularity with the development of termite detection stations. As it is known that termites forage randomly about 50 mm below the surface of the soil in an area of about 0.3-0.4 hectares surrounding a nest, it is possible to detect the presence of termites near a dwelling using strategically placed detection stations. A typical detection station comprises a plastic cylinder with or without a collar about an access port having a removable closure cap. The cylinder includes a softwood block accessible via apertures in the cylinder wall when the station is buried in the soil with the closure cap exposed. When found by foraging termites, a feeding connection is established but this can take up to several months. Once the feeding cycle is established and determined by regular viewing of the interior of the baiting station, a toxic substance mixed with a cellulosic feed base is inserted into the baiting station or inserted into the soil adjacent the baiting station in a hollow perforated stake.

Generally speaking, the termiticides used fall into either of two groups—a chitin synthesis inhibitor or a stomach poison. Chitin synthesis inhibitors are hormonal in nature and prevent moulting of the exoskeleton in immature worker termites. Known chitin synthesis inhibitors include Hexaflumuron and Diflubenzuron. Ultimately, the non-foraging termites, including the queens, soldiers and reproductives, which in any event are unaffected by the chitin synthesis inhibitors, die of starvation. This process can take several months and requires constant supervision and replenishment of the stakes containing the termiticide.

The so-called “stomach poison” class of termiticides which include sulfluramid and sodium borate, directly poison termites feeding on cellulosic materials impregnated therewith. Sulfluramid is a slow acting toxin thought to kill protozoa in the termite's gut which enable digestion of cellulose foods. Sodium borate is typically sprayed onto infested timbers and works in a similar manner to sulfluramid—both taking from 60-90 days to kill the termites.

Colony baiting can be effective for detection and eradication of termites externally of a structure such as a domestic dwelling provided that sufficient bait stations are employed and that adequate and regular supervision and replacement of baited stakes occurs. There are some “do-it-yourself” kits available for homeowners for detection and eradication of termites as these do not require the services of a licensed operator to install. However the majority of termite treatment processes require the services of a licensed professional installer to install, monitor and maintain the termite detection and eradication systems.

Generally speaking, systems for detection of internal termite infestations are not employed unless there is evidence of or at least a good reason to suspect termite infestation. Methods for the detection of termite infestations include non-intrusive or non-destructive tests such as acoustic tests utilizing differing impact devices, moisture detection devices, acoustic emission devices such as a stethoscope or an electronic monitoring device. Intrusive devices may include a pointed probe, a boroscope or other optical devices inserted into a structure through a preformed aperture.

Once evidence of a termite infestation is located in, say, a skirting board, architrave or a window or door style there is available a professionally installed termite baiting station which is secured over the infested site by screws or the like. The bait station comprises a moulded plastics box-like body with four side walls, a removable front wall secured by screws and an open rear wall. After forming an enlarged access aperture in the timber member in which infestation is discovered, the open body is secured by mounting lugs to the surface of the timber member around the aperture. A licensed operator then mixes a batch of cellulosic feed such as α methylcellulose with water and an appropriate toxin such as a chitin synthesis inhibitor or a stomach poison to form a stiff paste which is loaded into the open body of the baiting station. When fully loaded, the front wall is screwed onto the body to form a sealed chamber.

While generally effective for their intended purpose, such internal baiting stations suffer a number of disadvantages. Due to the nature of the termiticide compounds used and the fact that a fresh batch of feed containing the termiticide must be mixed on site prior to sealing the bait container, only licensed operators may install the baiting stations. Moreover, as frequent inspections and refills are required this is not only a costly exercise for the homeowner but the removal of the front cover plate at regular intervals can disturb the feeding cycle of the termite and seriously protract the treatment time required to eradicate a nest.

Accordingly, it is an aim of the present invention to provide a method and apparatus for the detection and/or eradication of termites both in subterranean environments and in structures, which method and apparatus overcome or alleviate at least some of the shortcomings of prior art systems.

### SUMMARY OF THE INVENTION

According to a first aspect of the apparatus there is provided a bait station for distribution of a termiticide to foraging termites, said bait station comprising:—

a bait station for distribution of a termiticide to foraging termites, said bait station comprising:—

a hermetically sealed hollow body containing a cellulosic feedstuff and a termiticide, said hollow body having a plurality of closed apertures therein at least one of said apertures being exposable to provide, in use, an access port for termites to enter said hollow body, said hollow body being adapted for a hermetically sealed mounting on a structure containing termites with said access port forming a pathway between an interior cavity of said hollow body and termite pathways in said structure communicating with a termite colony, said bait station characterized in that barrier located between said access port and said termiticide prevents direct access to said termiticide when said at least one aperture is exposed.

Suitably, said cellulosic feedstuff comprises a cellulosic matrix of particulate material having a termiticide dispersed therein.

The cellulosic matrix may be incorporated into said hollow body as a flowable particulate material.

Alternatively, said cellulosic matrix may comprise a compressed body of particulate material with or without a binder.

If required, said cellulosic matrix may be present in said hollow body as a hydrated mass occupying substantially the entire interior cavity of said hollow body.

The termiticide may be selected from any suitable termiticide including borate compounds, chitin synthesis inhibitors, nicotinoids, phenol ureas, phenol pyrazoles.

Suitably, a termite attractant composition may be incorporated in said cellulosic matrix.

Alternatively, said attractant composition may be incorporated in a barrier layer of corrugated cellulosic material disposed between said cellulosic matrix and an inner wall of said hollow body.

The termite attractant composition may be selected from any suitable attractant including allantoin, ellagic acid, hydroxycoumarin, urea.

The hollow body may comprise a viewing port.

If required, the viewing port may include an indicator which, in use, indicates the presence of termites adjacent thereto in said hollow body.

Preferably, said bait station is adapted for coupling to an adjacent bait station via alignable apertures in respective hollow bodies.

The bait station may be adapted for coupling to an adjacent bait station via a hollow conduit communicating with respective interior cavities of said bait stations.

1. A bait station for distribution of a termiticide to foraging termites, said bait station comprising:—
a hermetically sealed hollow body containing a cellulosic feedstuff and a termiticide, said hollow body having a plurality of closed apertures therein at least one of said apertures being exposable to provide, in use, an access port for termites to enter said hollow body, said hollow body being adapted for a hermetically sealed mounting on a structure containing termites with said access port forming a pathway between an interior cavity of said hollow body and termite pathways in said structure communicating with a termite colony, said bait station characterized in that barrier located between said access port and said termiticide prevents direct access to said termiticide when said at least one aperture is exposed.

2. A bait station as claimed in claim 1 wherein said barrier comprises a cellulosic liner.

3. A bait station as claimed in claim 1 wherein said barrier comprises a perforatable membrane.
